(19) United States
(12) Patent Application Publication
(10) Pub. No.: US 2014/0172364 A1
(43) Pub. Date: Jun. 19, 2014

(54) TIME-DETECTING DEVICE AND METHOD

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: YA-GUO WANG, Shenzhen (CN); CHUN-CHING CHEN, New Taipei (TW)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/078,584

(22) Filed: Nov. 13, 2013

(30) Foreign Application Priority Data
Dec. 13, 2012 (CN) 201210536761X

(51) Int. Cl. G04F 10/00

(52) U.S. Cl. CPC G04F 10/00
USPC 702/178

(57) ABSTRACT

A time-detecting device detects a time duration of a burn-in test performed by an electronic device. The electronic device generates a first signal and a second signal when the burn-in test is started and stopped, respectively. The time-detecting device comprises a timing unit, a processor, and an outputting unit. The timing unit counts the time duration of the burn-in test from a default starting value in response to receiving the first signal. The processor determines whether the burn-in test is stopped according to the second signal. The output unit outputs the time duration when the processor determines that the burn-in test is stopped.

### BACKGROUND

1. Technical Field

The present disclosure relates to a time-detecting device and a time-detecting method applied to a time-detecting device.

2. Description of Related Art

Disc players, such as digital video disc (DVD) players, play a disc and display the playing time of the disc on a display. When the disc player has been manufactured, the disc player needs to undergo a burn-in test to determine whether the disc player is qualified. Generally, the method of the burn-in test is to enable the disc player to play a testing disc for an extended period of time, such as 12 hours. A tester determines whether the burn-in test is finished by periodically viewing the playing time on the display. However, if the burn-in test is interrupted and the disc player stops playing and is powered off, the playing time on the display disappears. The tester may not timely view the playing time, and cannot accurately determine how long the burn-in test has lasted. Thus, the tester may need to run the burn-in test again, which wastes a lot of time.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a function block diagram of a time-detecting device in accordance with an embodiment.

FIG. 2 is a flowchart of a time-detecting method in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

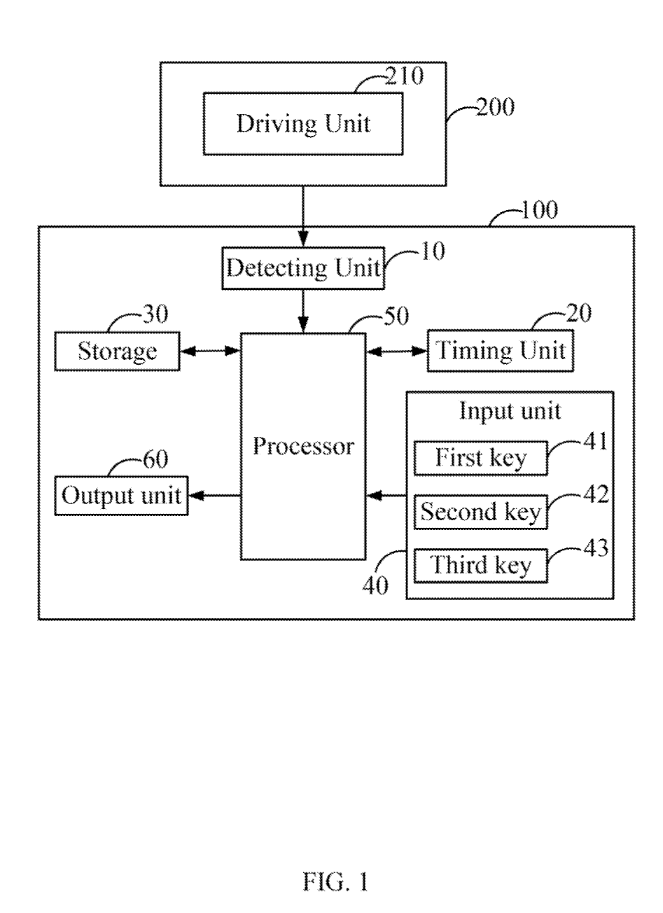

FIG. 1 shows a time-detecting device 100 in accordance with an embodiment. The time-detecting device 100 electronically connects to an electronic device, such as a disc player 200. The disc player 200 includes a driving unit 210 for playing a testing disc for a predetermined time period to perform a burn-in test. The disc player 200 sends a first signal to the time-detecting device 100 when the driving unit 210 begins playing the testing disc, and sends a second signal to the time-detecting device 100 when the driving unit 210 stops playing the testing disc. The time-detecting device 100 detects and stores a time duration of the burn-in test, so that a user can obtain the time duration as needed.

The time-detecting device 100 includes a detecting unit 10, a timing unit 20, storage 30, an input unit 40, a processor 50, and an output unit 60. The detecting unit 10, the timing unit 20, the storage 30, the input unit 40, and the output unit 60 are each electronically connected to the processor 50.

The detecting unit 10 is electronically connected to the driving unit 210 to detect a start and stop time of the burn-in test. When the detecting unit 10 receives the first signal, the detecting unit 10 determines that the burn-in test is started and sends a first detecting signal to the processor 50 in response to receiving the first signal. When the detecting unit 10 receives the second signal, the detecting unit 10 determines that the burn-in test is stopped and sends a second detecting signal to the processor 50 in response to receiving the second signal. In another embodiment, the processor 50 can directly receive the first signal and the second signal from the driving unit 210.

The timing unit 20 counts the time duration of the burn-in test from a default starting value under the control of the processor 50. In one embodiment, the timing unit 20 begins counting the time duration from a default starting value of zero at the first timing of the burn-in test, and then the default starting value is set by the processor 50 in response to the user's operation.

The storage 30 stores the time duration counted by the timing unit 20 under the control of the processor 50. In one embodiment, the storage 30 is a nonvolatile memory, such as an electrically erasable programmable read-only memory (EEPROM). Thus, the time duration stored in the storage 30 will not be lost when the time-detecting device 100 is powered off.

The input unit 40 generates different signals in response to different user's operations. In one embodiment, the input unit 40 includes several keys (41, 42, 43) set on the time-detecting device 100. The signals include an output signal, a setting signal, and a reset signal. If the burn-in test is interrupted, the user can view the time duration stored in the storage 30 to determine how long the burn-in test has lasted. In this situation, a first key 41 is manually pressed. The input unit 40 generates the output signal in response to pressing the first key 41, and sends the output signal to the processor 50. If the burn-in test is interrupted because of external interruptions, the user can set the time duration as the default starting value of the timing unit 20 to continue timing the burn-in test from the point of interruption. In this situation, a second key 42 is manually pressed. The input unit 40 generates the setting signal in response to pressing the second key 42 and sends the setting signal to the processor 50. If the burn-in test is interrupted by the malfunctions of the disc player 100 or the burn-in test has finished, the user can reset the default starting value to zero and erase the time duration stored in the storage 30. In this situation, a third key 43 is manually pressed. The input unit 40 generates the reset signal in response to pressing the third key 43 and sends the reset signal to the processor 50.

The processor 50 controls the timing unit 20 to begin counting the time duration in response to receiving the first detecting signal, and controls the timing unit 20 to stop counting the time duration in response to receiving the second detecting signal. The processor 50 also controls the storage 30 to store the time duration counted by the timing unit 20. The processor 50 further determines whether the time duration counted by the timing unit 30 reaches a predetermined time period. If the time duration reaches the predetermined time period, the processor 50 controls the output unit 60 to output a first message to indicate that the burn-in test is finished. If the time duration does not reach the predetermined time period, the processor 50 further determines whether the processor 50 receives the second detecting signal from the detecting unit 10. If the processor 50 receives the second detecting signal, the processor 50 controls the output unit 60 to output a second message to indicate that the burn-in test is unfinished, and controls the output unit 60 to output the time duration. In another embodiment, if the time duration reaches the predetermined time period, the processor 50 controls the output unit 60 to output a first message to indicate that the burn-in test is finished, and then sets the default starting value to zero. If the processor 50 receives the second detecting signal, the processor 50 controls the output unit 60 to output a second message to indicate that the burn-in test is unfinished, and then set the time duration as the default starting value of the timing unit 20.

The processor 50 also executes the corresponding operations in response to the signals received from the input unit 40. In detail, when the processor 50 receives the output signal, the processor 50 reads the time duration from the storage 30 and then sends the time duration to the output unit 60. When the processor 50 receives the setting signal, the time duration stored in the storage 30 is read and then set as the default starting value. When the processor 50 receives the reset signal, the default starting value of the timing unit 20 is reset to zero and the time duration stored in the storage 30 is erased.

The output unit 60 outputs the time duration of the burn-in test, the first message or the second message under the control of the processor 50. In one embodiment, the output unit 60 is a display. In other embodiments, the output unit 60 can be a speaker outputting the duration of the burn-in test.

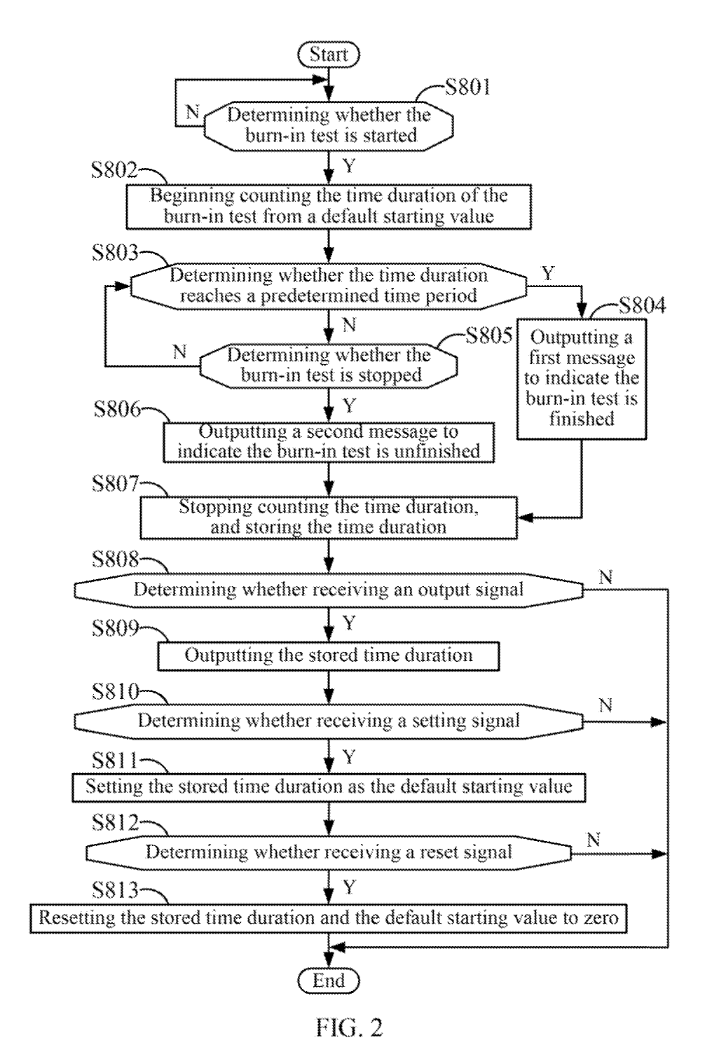

FIG. 2 shows a flowchart of a time-detecting method applied to the time-detecting device 100. The time-detecting method includes the following steps.

In step S801, the detecting unit 10 determines whether the burn-in test is started. If the burn-in test is started, the process goes to step S802. If the burn-in test is not started, the process repeats step S801. The detecting unit 10 determines that the burn-in test is started upon receiving the first signal from the disc player 200. The detecting unit 10 sends the first detecting signal to the processor 50 in response to receiving the first signal.

In step S802, the time unit 20 begins counting the time duration of the burn-in test from a default starting value in response to receiving the first detecting signal. In one embodiment, the timing unit 20 begins counting the time duration from a default starting value of zero at the first timing of the burn-in test, and then the default starting value is set by the processor 50 in response to the user's operation.

In step S803, the processor 50 determines whether the time duration counted by the timing unit 20 reaches a predetermined time period. If the time duration reaches the predetermined time period, the process goes to step S804. If the time duration does not reach the predetermined time period, the process goes to step S805.

In step S804, the output unit 60 outputs the first message to indicate that the burn-in test is finished, and the process goes to step S807. In another embodiment, the output unit 60 outputs the first message to indicate that the burn-in test is finished and sets the default starting value to zero.

In step S805, the detecting unit 10 determines whether the burn-in test is stopped. If the burn-in test is stopped, the process goes to step S806. If the burn-in test is not stopped, the process goes back to step S803. In one embodiment, the detecting unit 10 determines that the burn-in test is stopped upon receiving the second signal from the driving unit 210, and then the detecting unit 10 sends the second detecting signal to the processor 50 in response to receiving the second signal.

In step S806, the output unit 60 outputs the second message to indicate that the burn-in test is unfinished. In another embodiment, the output unit 60 outputs the second message to indicate that the burn-in test is unfinished and sets the time duration as the default starting value of the timing unit 20.

In step S807, the timing unit 20 stops counting the time duration of the burn-in test, the storage 30 stores the time duration, and the output unit 60 outputs the time duration.

In step S808, whether the processor 50 receives the output signal is determined. When the processor 50 receives the output signal, the process goes to step S809. When the processor 50 does not receive the output signal, the process ends. When the burn-in test is interrupted, the user can view the time duration stored in the storage 30 to determine how long the burn-in test has lasted. The input unit 40 generates the output signal in response to a first user's operation.

In step S809, the output unit 60 outputs the time duration stored in the storage 30 under the control of the processor 50.

In step S810, whether the processor 50 receives the setting signal is determined. When the processor 50 receives the setting signal, the process goes to step S811. When the processor 50 does not receive the setting signal, the process ends. When the burn-in test is interrupted because of external interruptions, the user can set the time duration as the default starting value of the timing unit 20 so as to continue timing the burn-in test from the point of interruption. The input unit 40 generates the setting signal in response to a second user's operation.

In step S811, the processor 50 reads the time duration stored in the storage 30, and then sets the time duration as the default starting value of the timing unit 20.

In step S812, whether the processor 50 receives the reset signal is determined. When the processor 50 receives the reset signal, the process goes to step S813. When the processor 50 does not receive the reset signal, the process ends. When the burn-in test is interrupted by malfunctions of the disc player 200 or the burn-in test has finished, the user can reset the time duration stored in the storage 30. The input unit 40 generates the reset signal in response to a third user's operation.

In step S813, the processor 50 resets the duration stored in the storage 30 in response to receiving the reset signal.

It should be noted that for the aforementioned embodiment of the burn-in testing method, steps S808, S810 and S812 are not limited to follow the expressed sequence, because the user determines the signal the processor 50 receives.

As described above, the time-detecting device 100 can store the duration of the burn-in test. When the burn-in test is interrupted because of external malfunctions, the user can set the duration stored in the storage 30 as the default starting value of the timing unit 20 so as to continue timing the burn-in test from the point of interruption. Thus, time is saved, and efficiency of the burn-in test is improved.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A time-detecting device, for detecting a time duration of a burn-in test performed by an electronic device, the electronic device sending a first signal and a second signal to the time-detecting device when the burn-in test is started and stopped respectively, the time-detecting device comprising:
a timing unit for counting the time duration of the burn-in test from a default starting value in response to the first signal;
a processor for determining whether the burn-in test is stopped according to the second signal; and
an output unit for outputting the time duration when the processor determines that the burn-in test is stopped.

2. The time-detecting device of claim 1, wherein the processor determines whether the time duration counted by the timing unit reaches a predetermined time period; when the time duration reaches the predetermined time period, the output unit outputs a first message to indicate that the burn-in test is finished.

3. The time-detecting device of claim 2, wherein the default starting value is set to zero when the burn-in test is finished.

4. The time-detecting device of claim 2, wherein the processor further determines whether the burn-in test is stopped when the time duration does not reach the predetermined time period; when the processor determines the burn-in test is stopped, the processor controls the output unit to output a second message to indicate that the burn-in test is unfinished, and the time duration is set as the default starting value.

5. The time-detecting device of claim 1, wherein the time-detecting device further comprises storage for storing the time duration counted by the timing unit.

6. The time-detecting device of claim 5, wherein the time-detecting device further comprises an input unit, the input unit receives a first user's operation and generates an output signal in response to the first user's operation; the processor controls the output unit to output the time duration in response to receiving the output signal.

7. The time-detecting device of claim 6, wherein the input unit receives a second user's operation and generates a setting signal in response to the second user's operation; the processor reads the time duration from the storage in response to the setting signal, and then sets the time duration as the default starting value.

8. The time-detecting device of claim 6, wherein the input unit receives a third user's operation and generates a reset signal in response to the third user's operation; the processor resets the default starting value to zero and erases the time duration stored in the storage in response to the reset signal.

9. A time-detecting method executed by a time-detecting device, the time-detecting device detecting a time duration of a burn-in test performed by the electronic device, the time-detecting method comprising:
determining whether the burn-in test is started;
beginning counting the time duration of the burn-in test from a default starting value when the burn-in test is started;
determining whether the burn-in test is stopped; and
stopping counting the time duration of the burn-in test and outputting the time duration.

10. The time-detecting method of claim 8, wherein before the step of determining whether the burn-in test is stopped, the time-detecting method further comprises the step of determining whether the time duration reaches a predetermined time period.

11. The time-detecting method of claim 10, further comprising the step of outputting a first message to indicate that the burn-in test is finished when the time duration reaches the predetermined time period.

12. The time-detecting method of claim 11, further comprising the step of setting the default starting value to zero when the time duration reaches the predetermined time period.

13. The time-detecting method of claim 11, further comprising the step of outputting a second message to indicate that the burn-in test is unfinished and setting the time duration as the default starting value when determining the burn-in test is stopped.

14. The time-detecting method of claim 9, further comprising the step of storing the time duration when determining the burn-in test is stopped.

15. The time-detecting method of claim 14, wherein the time-detecting device is capable of generating an output signal in response to a first user's operation, the time-detecting method further comprising the step of determining whether receiving the output signal, and outputting the stored time duration when receiving the output signal.

16. The time-detecting method of claim 15, wherein the time-detecting device is capable of generating a setting signal in response to a second user's operation, the time-detecting method further comprising the step of determining whether receiving the setting signal, and setting the stored duration as the default starting value when receiving the setting signal.

17. The time-detecting method of claim 15, wherein the time-detecting device is capable of generating a reset signal in response to a third user's operation, the time-detecting method further comprising the step of determining whether receiving the reset signal, and resetting the default starting value to zero and erasing the stored time duration when receiving the reset signal.
